(19) United States
(12) Patent Application Publication
(10) Pub. No.: US 2009/0242782 A1
(43) Pub. Date: Oct. 1, 2009

(54) SURFACE DIODE SENSOR FOR MEGAVOLTAGE RADIATION THERAPY MACHINES WITH REDUCED ANGULAR SENSITIVITY

(76) Inventors: Paul A. Jursinic, Kalamazoo, MI (US); Daniel G. Schmidt, Blanchardville, WI (US)

Correspondence Address: BOYLE FREDRICKSON S.C., 840 North Plankinton Avenue, MILWAUKEE, WI, 53203, US

(21) Appl. No.: 12/400,873

(22) Filed: Mar. 10, 2009

Related U.S. Application Data
(60) Provisional application No. 61/035,257, filed on Mar. 10, 2008.

(51) Int. Cl. G01T 1/26; G01D 18/00

(52) U.S. Cl. 250/371; 378/207

(57) ABSTRACT

An improved diode sensor for calibration of megavoltage radiation machines eliminates high atomic number metallic components adjacent to a bottom surface of the diode substrate (away from the depletion region) to decrease a sensitivity of the diode sensor to incident angle of the radiation.

### CROSS-REFERENCE TO RELATED APPLICATIONS

This application claims the benefit of U.S. provisional application 61/035,257 filed Mar. 10, 2008 hereby incorporated by reference.

### STATEMENT REGARDING FEDERALLY SPONSORED RESEARCH OR DEVELOPMENT

### BACKGROUND OF THE INVENTION

Radiation therapy provides for the treatment of cancer patients using high-energy radiation (as used herein: photons, electrons or other particles) in the megavoltage or million electron volt range (henceforth megavoltage radiation). A treatment regime may employ a high dose, 180 cGy per day, for 30 to 40 consecutive daily treatments.

It is important that such radiation therapy equipment be properly calibrated to ensure that the patient is neither over-exposed nor under-exposed. Ideally, this calibration employs in vivo dosimetry in which a radiation sensor used for calibration is placed directly on the patient in the desired treatment area, however other quality assurance measurements utilizing watertank systems or phantoms are also commonly used for calibrations.

In vivo dosimetry has traditionally been provided by thermoluminescent dosimeters (TLD), optically stimulated luminescent dosimeters (OSLD), MOSFET detectors, and PN-junction diodes.

While diodes have some advantages in cost, simplicity of use, and size, one current drawback to the use of diodes as radiation detectors is that they are highly sensitive to the angle of incidence of the radiation, exhibiting as much as ±25% change in sensitivity based on that angle. This angle sensitivity is a problem when the sensor is attached to a surface of the patient that is angled with respect to the radiation beam. Such sensitivity also creates problems when the radiation treatment is delivered with arc therapy, rotational therapy or tomotherapy machines where the radiation source changes direction during the exposure.

### SUMMARY OF THE INVENTION

The present inventors have determined that a large portion of the angle sensitivity of PN-junction photodiodes can be traced to the metallic electrode underlying the diode substrate and used as one contact for the diode. By adopting a novel architecture in which the contacts are moved away from this surface, angular dependence in sensitivity of the diode is strikingly reduced and, further, an improvement in uniformity of sensitivity is obtained over a range of radiation energy.

Specifically then, the present invention provides a calibration sensor for high-energy radiation therapy machines, the calibration sensor including a sensor support holding a semiconductor diode having a heterojunction formed between a first and second junction material. The first junction material is attached at a first face to the sensor support without an intervening metallic contact with the second junction material exposed at a second face opposite the first face. First and second contact leads communicate with the first and second junction materials at locations removed from the first face.

It is thus one feature of at least one embodiment of the invention to provide decreased angular sensitivity in a diode used for measuring high-energy radiation by removing the metallic contact from the underside of the diode substrate.

The sensor support is constructed of a low atomic number material equivalent to an element having an atomic number of less than 11 and may be a polymer.

It is thus one feature of at least one embodiment of the invention to separate high Z materials from proximity with the bottom of the diode substrate.

The nonmetallic sensor support may be a polymer or polymer glass composite.

It is thus one feature of at least one embodiment of the invention to provide a substrate that can be used as a basis for a rigid or flexible printed circuit with traces used to connect to the diode.

A sensor circuit may be attached to the first and second contact leads for measuring current through the heterojunction and providing an output display indicating megavoltage radiation fluence.

It is thus one feature of at least one embodiment of the invention to provide a sensor suitable for megavoltage radiation.

The first and second contact leads may include wires having ends bonded to the first and second junction materials on the exposed second face.

It is thus one feature of at least one embodiment of the invention to provide a practical fabrication technique for a diode where one contact surface has been eliminated.

The sensor may further include a buildup material approximating the radiation transmission qualities of the sensor support and/or underlying semiconductor substrate, the buildup material applied over the second face.

It is thus one feature of at least one embodiment of the invention to further improve the uniform sensitivity of the diode to different incident angles of radiation by matching buildup materials on all sides of the diode.

The buildup material may include a metal layer at the second face of the semiconductor diode to equilibrate buildup material on both sides of the sensor region.

It is thus one feature of at least one embodiment of the invention to provide a compact build-up region.

The hetero junction area may be smaller than one (1) mm².

It is thus one feature of at least one embodiment of the invention to provide an extremely compact radiation sensor that may be used with small field radiation beams.

These particular features and advantages may apply to only some embodiments falling within the claims and thus do not define the scope of the invention.

### BRIEF DESCRIPTION OF THE DRAWINGS

FIG. 1 is a perspective view of a prior art photodiode mounted to a copper trace on printed circuit board;

FIG. 2 is a cross-section along line 2-2 of FIG. 1 showing the layers of the diode and printed circuit board;

FIG. 3 is a figure similar to that of FIG. 1 showing the diode sensor of the present invention;

FIG. 4 is a figure similar to that of FIG. 2, showing a cross-section along line 4-4 of FIG. 3;

FIG. 5 is a perspective view of the sensor of the present invention packaged with buildup material and attached to a display device for reading radiation fluence;

FIG. 6 is a cross-section along line 6-6 of FIG. 5 showing the buildup material augmented by a thin electrode on an upper surface of the diode when the sensor is applied to the skin of a patient;

FIG. 7 is a plot of data obtained from the diode of FIG. 1 of the prior art versus one example of the sensor the present invention showing decreased angle sensitivity of the signal from the present invention; and

FIG. 8 is a bar chart showing the sensitivity variations of one example of the sensor of the present invention as a function of radiation type and energy.

### DETAILED DESCRIPTION OF THE PREFERRED EMBODIMENT

Referring now to FIGS. 1 and 2, a prior art diode 10 may include a generally rectangular and planar silicon substrate 12 of P-type material approximately 250 μm thick. The silicon substrate may be p-doped and have an N-type depletion region 14 centered in and exposed at its upper surface about 10 μm deep. The depletion region 14 may be surrounded by a small margin of P-type material on the upper surface of the substrate 12.

A lower surface of the substrate 12 is metallized with a conductive film 16 which in turn is soldered to a copper trace 18. The copper trace 18 may be approximately 0.015 mm thick and adhered to the top of a support material 20 such as provided by a standard glass epoxy printed circuit board fabricated according to techniques known in the art. The copper trace 18 leads to a conductor 21 providing one terminal for the diode 10.

A metallized layer is applied in a ring about the periphery of the depletion region 14 creating an annular conductor 26 electrically attached to the depletion region 14 yet exposing the center of the depletion region 14 to light, allowing the diode in 10 to be used in conventional photosensing applications. A second conductor 22 being a trace on the support material 20 is connected to the annular conductor 26 by a wire 24 attached at each end by bonding techniques. Conductors 21 and 22 form electrical terminals of the sensor device connecting to the anode and cathode of the diode 10. Such diodes 10 having a depletion region 14 of approximately 1.6 mm in diameter are commercially available from Sun Nuclear of Melbourne Fla.

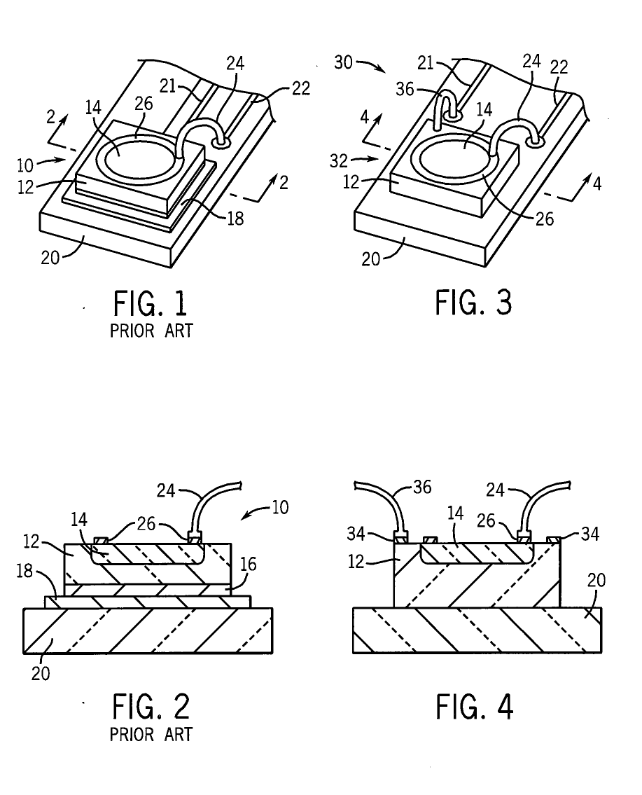

Referring now to FIG. 3, a megavoltage radiation sensor 30 of the present invention may employ a similar diode 32 having a substrate 12 and depletion region 14 of the same form as described with respect to FIG. 1. In contrast to the previously described diode 10, however, diode 32 does not have a conductive film 16 on its lower surface and, instead, the lower surface is attached directly to the support material 20 by adhesive or the like so that the substrate 12 is proximate only to low atomic number material. In this context, “low atomic number” means materials that exclude atomic numbers equal or greater to those of the metals other than aluminum, or for example those with atomic numbers greater than 20.

In order to provide electrical connection to the substrate 12, a periphery of the upper surface of the substrate 12 outside of the depletion region 14 and outside of the annular conductor 26 (and electrically isolated therefrom) is metallized by a metal region 34 communicating electrically with the substrate 12. The metal region 34 is attached to a wire 36 (by wire bonding) to conductor 21 on the support material 20. Likewise, a second conductor 22 on the support material 20 connects as before by wire 24 to the annular conductor 26. As before, conductors 21 and 22 form electrical terminals of the sensor device.

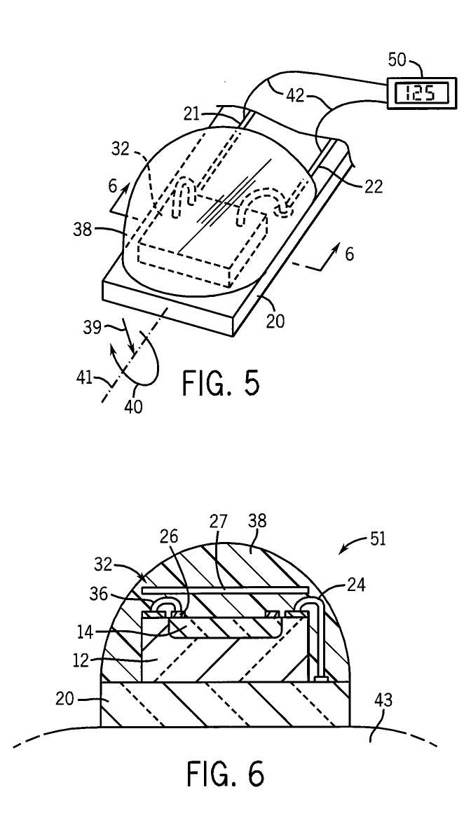

Referring now to FIG. 5, the diode 32 may be coated with a hermetic epoxy coating, for example 0.4 mm in thickness, to protect the diode 32 and to provide “buildup material” 38 comparable to that of the support material 20, so that radiation 39 at a range of angles 40 about an axis 41 through the diode 32 and generally parallel to a plane of the support material 20 will pass through an equivalent amount of material before striking the depletion region 14. The buildup material 38 is preferably opaque to visible light.

Conductors 21 and 22 are attached through leads 42 to sensitive integrating amplification circuitry 50 of a type known in the art for measuring photocurrents generated by radiation striking the heterojunction of the diode 32. These photocurrents when properly calibrated provide a reading of radiation fluence.

Referring now to FIG. 6, the buildup material 38 may be, for example, a water equivalent material of a type known in the art. In addition to the buildup material 38, a high atomic number build-up disk 27 of approximately 0.05 mm thick copper may be placed to cover the depletion region 14. This build up disk 27 blocks visible light and enhances the properties of the buildup material 38, and acts to backscatter low energy electrons.

The resulting sensor 51, comprising the support material 20, diode 32, and the buildup material 38, may be applied to the skin of the patient 43 near the area of treatment.

### EXAMPLE I

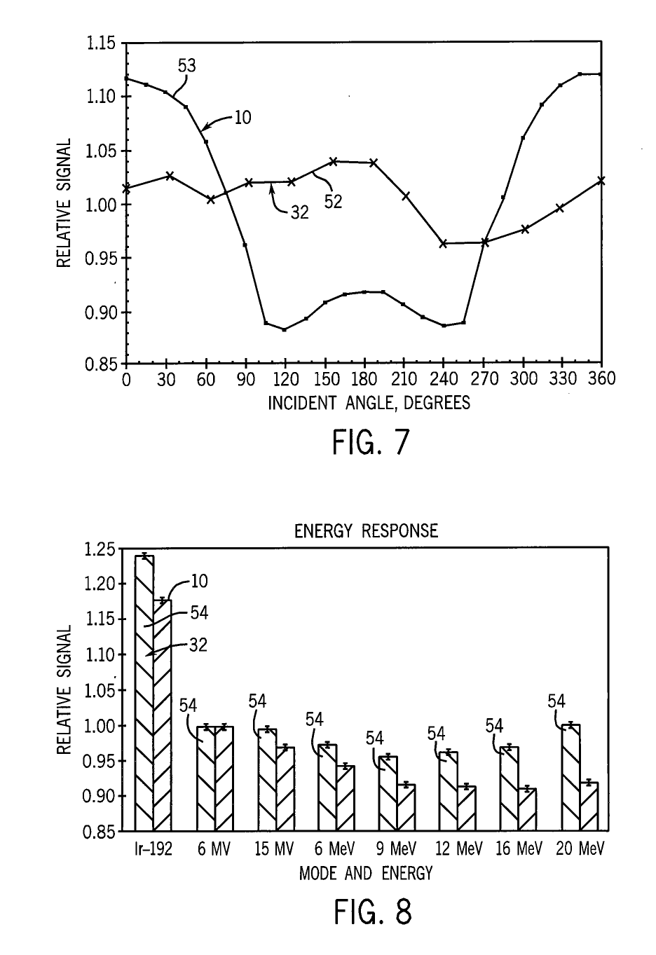

Referring to FIGS. 5 and 7, a diode 10 per the teachings of FIG. 1 was compared to a diode 32 of the present invention in the configuration of FIG. 3 with respect to 6-megavolt radiation applied over the range of angles 40.

The prior art diode 10 provided an output indicated by curve 53 exhibiting a substantially higher angular sensitivity (fluctuation over 360° of angle) than the diode 32 of the present invention whose output is indicated by curve 52.

The diodes in both cases use similar substrates 12 and depletion regions 14. The diode 32 was obtained commercially from Silicon Sensor GmbH of Berlin Germany sold under the trade name of “Si PIN photodiodes Series 2” being ultraviolet/blue enhanced photodiodes having an active area defined by the area of the depletion region 14 of approximately 1 mm² and being sensitive to optical radiation in the range of 200 nm to 1100 nm.

In preparing the graph of FIG. 7, exposures were made with a 10 cm×10 cm field at 100 cm from the 6-megavolt radiation source of a linear accelerator with the sensors mounted in the center of cylindrical phantoms of 1.5 cm water equivalent wall thickness. Angle zero is where the angle of the radiation 39 is normal to the upper surface of the substrate 12.

The diodes 32 of the present invention were found to have the following characteristics: a dependence on incident angle 40 of radiation 39 of ±3.6% after 10 kGy of pre-irradiation, a 1.6% change in sensitivity over a 260 fold change in dose per pulse, an aerial density of 0.09 g per square centimeter, and linearity in response to does from 5-220 cGy.

Referring now to FIG. 8, compared to a baseline of six megavolt x-rays, the sensitivity to dose 54 for the diode 32 of the present invention remains within 4% for energies between six megavolts and 15 megavolts and between 6 million electron volts and 20 million electron volts.

It is specifically intended that the present invention not be limited to the embodiments and illustrations contained herein and the invention should be understood to include modified forms of those embodiments including portions of the embodiments and combinations of elements of different embodiments as come within the scope of the following claims. It is believed, for example, that the P- and N-dopings of the diode may be reversed and that a wide variety of heterojunction materials may be used.

We claim:

1. A calibration sensor for a high-energy radiation therapy machine comprising:
a sensor support;
a semiconductor diode having a heterojunction formed between a first and second junction material, the first junction material attached at a first face to the sensor support without an intervening metallic contact and the second junction material exposed at a second face opposite the first face; and
a first and second contact lead communicating with the first and second junction materials at locations removed from the first face.

2. The calibration sensor of claim 1 wherein the sensor support is a low atomic number material equivalent to an element having an atomic number of less than 11.

3. The calibration sensor of claim 2 wherein the sensor support is a polymer or polymer glass composite.

4. The calibration sensor of claim 1 further including a sensor circuit attached to the first and second contact leads for measuring current through the heterojunction and providing an output display indicating megavoltage radiation fluence.

5. The calibration sensor of claim 1 wherein the first and second contact leads include wires having ends bonded to the first and second junction materials on the second face.

6. The calibration sensor of claim 1 further including a buildup material having radiation transmission qualities approximating at least one of the sensor supports and underlying tissue and applied over the second face of the semiconductor diode.

7. The calibration sensor of claim 6 wherein the buildup material is a polymer.

8. The calibration sensor of claim 7 wherein the buildup material includes a metal layer on the second face of the diode.

9. The calibration sensor of claim 1 wherein an area of heterojunction along the second face is smaller than one (1) mm².

10. A method of measuring megavoltage radiation comprising the steps of:
(a) placing a sensor in the path of a radiation beam to be measured, the sensor comprising a nonmetallic sensor support holding a semiconductor diode having a heterojunction formed between a first and second junction material, the first junction material attached at a first face to the sensor support without an intervening metallic contact and the second junction material exposed at a second face opposite the first face;
(b) applying a megavoltage radiation beam to the sensor at a variety of angles;
(c) monitoring current between a first and second contact lead communicating with the first and second junction materials at locations removed from the first face; and
(d) outputting a measure of radiation fluence.
